(19) United States
(12) Patent Application Publication
(10) Pub. No.: US 2026/0293812 A1
(43) Pub. Date: Oct. 1, 2026

(54) ONBOARD PUMP ASSEMBLY FOR AN AGRICULTURAL SYSTEM

(71) Applicant: CNH Industrial America LLC, New Holland, PA (US)

(72) Inventors: Jared Mark Rose, Dillsburg, PA (US); Cale Boriack, Lititz, PA (US)

(21) Appl. No.: 19/634,327

(22) Filed: Mar. 31, 2026

Related U.S. Application Data
(60) Provisional application No. 63/781,070, filed on Mar. 31, 2025.

(51) Int. Cl. A01D 69/03; A01D 69/02; A01D 69/12

(52) U.S. Cl. CPC A01D 69/03; A01D 69/025; A01D 69/12

(57) ABSTRACT

An onboard pump assembly for an agricultural system includes an onboard pump and a valve assembly. The onboard pump is configured to supply a working fluid to an operational output from an onboard reservoir and fill the onboard reservoir with the working fluid from a bulk reservoir. Furthermore, the valve assembly is configured to transition states. While in the operational state, the valve assembly establishes a first connection between the onboard reservoir and an input end of the onboard pump, establishes a second connection between the operational output and an output end of the onboard pump, and blocks the bulk reservoir. While in the filling state, the valve assembly establishes a third connection between the bulk reservoir and the input end of the onboard pump, establishes a fourth connection between the onboard reservoir and the output end of the onboard pump, and blocks the operational output.

### CROSS-REFERENCE TO RELATED APPLICATION

This application claims priority from and the benefit of U.S. Provisional Application Serial No. 63/781,070, entitled “ONBOARD PUMP ASSEMBLY FOR AN AGRICULTURAL SYSTEM”, filed MAR 31, 2025, which is hereby incorporated by reference in its entirety.

### BACKGROUND

The present disclosure relates generally to an onboard pump assembly for an agricultural system.

Agricultural harvesters are used to harvest agricultural products (e.g., cotton or other natural material(s)). For example, an agricultural harvester may include a header having row units configured to harvest the agricultural product from a field. The agricultural harvester may also include an air-assisted conveying system configured to move the agricultural product from the row units to an accumulator. The agricultural product may then be fed into a baler via a conveying system. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale.

Certain row units include two rotors, and each rotor includes multiple spindles (e.g., barbed spindles) configured to engage a crop (e.g., a cotton plant). Generally, each rotor is configured to rotate about a central shaft (e.g., rotor shaft). The rotors may be positioned on opposite sides of a central path or on the same side of the central path, and the spindles extend into the central path. During operation of the agricultural harvester, the row unit is positioned to align a row of crops with the central path. Accordingly, as the agricultural harvester traverses the field, the spindles of the rotors engage each plant of the row. The rotors are driven to rotate, such that engagement of the spindles with the crop separates the agricultural product (e.g., seed cotton) from the plant stalk. The agricultural product collects on the spindles and is removed from the spindles by doffers, which are positioned adjacent to the rotors. The air-assisted conveying system moves the agricultural product from the row unit to the accumulator. After the agricultural product is removed from the spindles of each rotor, the spindles pass through a respective moistener column assembly to remove buildup of crop liquids (e.g., sap, etc.) from the spindles. Rotation of the rotors then drives the spindles to engage a subsequent crop, while the plant stalk remains attached to the ground. To facilitate the rotation of the rotors, a bar lube system may be used to lubricate bearing(s) coupled to each central shaft. The bar lube system includes an onboard tank of a working fluid (e.g., grease, bar lube, drying agent, anti-spoilage liquid, water, etc.), which may be periodically refilled. The process of refilling the onboard tank of a working fluid may be difficult, complex, and time-consuming.

### BRIEF DESCRPTION

In certain embodiments, an onboard pump assembly for an agricultural system includes an onboard pump and a valve assembly. The onboard pump is configured to supply a working fluid to an operational output from an onboard reservoir and fill the onboard reservoir with the working fluid from a bulk reservoir. Furthermore, the valve assembly is configured to transition between an operational state and a filling state. While in the operational state, the valve assembly establishes a first connection between the onboard reservoir and an input end of the onboard pump, establishes a second connection between the operational output and an output end of the onboard pump, and blocks the bulk reservoir. While in the filling state, the valve assembly establishes a third connection between the bulk reservoir and the input end of the onboard pump, establishes a fourth connection between the onboard reservoir and the output end of the onboard pump, and blocks the operational output.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural harvester having an onboard pump assembly;

FIG. 2 is a schematic top view of an embodiment of a row unit that may be employed within the agricultural harvester of FIG. 1;

FIG. 3 is a perspective view of the row unit of FIG. 2;

FIG. 4 is a schematic diagram of an embodiment of an onboard pump assembly that may be employed within the agricultural harvester of FIG. 1;

FIG. 5 is a schematic diagram of another embodiment of an onboard pump assembly that may be employed within the agricultural harvester of FIG. 1;

FIG. 6. is a schematic diagram of a further embodiment of an onboard pump assembly that may be employed within the agricultural harvester of FIG. 1; and

FIG. 7. is a schematic diagram of an additional embodiment of an onboard pump assembly that may be employed within the agricultural harvester of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

An agricultural harvester may include at least one row unit having one or more rotors. Each rotor includes multiple spindles (e.g., barbed spindles) configured to engage a crop (e.g., a cotton plant). In addition, each rotor is configured to rotate about a central shaft (e.g., rotor shaft). In embodiments in which the row unit has two rotors, the rotors may be positioned on opposite sides of a central path or on the same side of the central path, and the spindles extend into the central path. The rotor(s) are driven to rotate, such that engagement of the spindles with the crop separates the agricultural product (e.g., seed cotton) from the plant stalk. To facilitate the rotation of the rotor(s), a bar lube system may be used to lubricate bearing(s) coupled to each central shaft. The bar lube system includes an onboard tank of a working fluid (e.g., grease, bar lube, drying agent, anti-spoilage liquid, water, etc.), which may be periodically refilled. An onboard pump assembly may be used in the refilling process.

In certain embodiments, the onboard pump assembly includes an onboard pump configured to supply a working fluid (e.g., grease, bar lube, drying agent, anti-spoilage liquid, water, etc.) to an operational output (e.g., extending to the bearing(s) coupled to the central shaft) from an onboard reservoir and to fill the onboard reservoir with the working fluid from a bulk reservoir. In addition, the onboard pump assembly includes a valve assembly configured to switch between an operational state and a filling state. In the operational state, the valve assembly establishes a first connection between the onboard reservoir and an input end of the onboard pump, establishes a second connection between the operational output and an output end of the onboard pump, and blocks the bulk reservoir. In the filling state, the valve assembly establishes a third connection between the bulk reservoir and the input end of the onboard pump, establishes a fourth connection between the onboard reservoir and the output end of the onboard pump, and blocks the operational output.

Furthermore, in certain embodiments, an onboard pump assembly includes a bi-directional onboard pump configured to supply a working fluid to an operational output from an onboard reservoir while operating in a first direction and to fill the onboard reservoir with the working fluid from a bulk reservoir while operating in a second direction, opposite the first direction. In addition, the onboard pump assembly includes a valve configured to facilitate flow of the working fluid from the onboard reservoir to the operational output while the bi-directional onboard pump is operating in the first direction and to block flow of the working fluid from the operational output to the onboard reservoir while the bi-directional onboard pump is operating in the second direction.

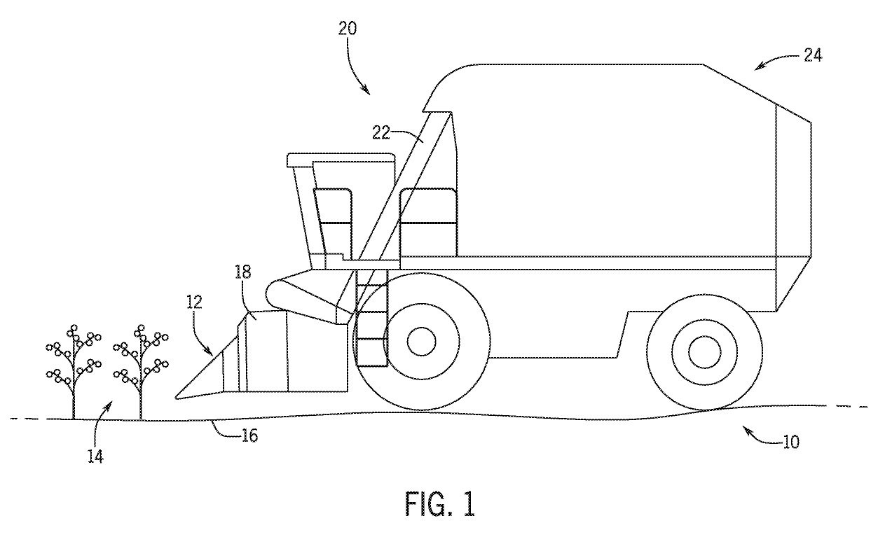

FIG. 1 is a side view of an embodiment of an agricultural harvester 10 having an onboard pump assembly. The agricultural harvester 10 is configured to harvest agricultural product 14 (e.g., seed cotton) from a field 16 and to form the agricultural product 14 into bales (e.g., agricultural bales). In the illustrated embodiment, a header 12 of the agricultural harvester 10 includes multiple row units 18 distributed across the width of the header 12. Each row unit 18 is configured to harvest a respective row of the agricultural product 14 from the field 16. Additionally, the agricultural harvester 10 includes an agricultural product transport assembly 20 having an air-assisted conveying system 22 configured to move the agricultural product 14 from the row units 18 of the header 12 to an accumulator of the agricultural product transport assembly 20. The agricultural product transport assembly 20 also includes a conveying system configured to convey the agricultural product 14 from the accumulator into a baler 24. The baler 24 is supported by and/or mounted within or on a chassis of the agricultural harvester 10. The baler 24 may form the agricultural product 14 into round bales. However, in other embodiments, the baler 24 of the agricultural harvester 10 may form the agricultural product into square bales, polygonal bales, or bales of other suitable shape(s). After forming the agricultural product 14 into a bale, a bale wrapping system of the agricultural harvester 10 wraps the bale with a bale wrap to secure the agricultural product 14 within the bale and to generally maintain a shape of the bale.

As discussed in detail below, each row unit 18 includes two rotors positioned on opposite sides of a central path through the row unit 18 or on the same side of the central path. Each rotor includes multiple spindles (e.g., barbed spindles) extending into the central path, and the spindles are configured to engage a crop (e.g., cotton plant) along a substantial portion of the height of the crop. During operation of the agricultural harvester 10, the central path of the row unit 18 is aligned with a row of crops. Accordingly, as the agricultural harvester 10 traverses the field 16, the row unit 18 receives each crop of the row, and the spindles of the rotors engage the crop. The rotors are driven to rotate, such that engagement of the spindles with the crop separates the agricultural product (e.g., seed cotton) from the plant stalk (e.g., the crop after the agricultural product is removed). The agricultural product removed from the crop collects on the spindles, and the agricultural product is removed from the spindles by doffers. Each doffer directs the agricultural product to a respective conveying chamber, and the air-assisted conveying system 22 moves the agricultural product from the conveying chambers to the accumulator. After the agricultural product is removed from the spindles of each rotor, the spindles pass through a respective moistener column assembly to remove buildup of crop liquids (e.g., sap, etc.) from the spindles. As the rotors continue to rotate, the spindles engage a subsequent crop at the central path, while the plant stalk remains attached to the ground.

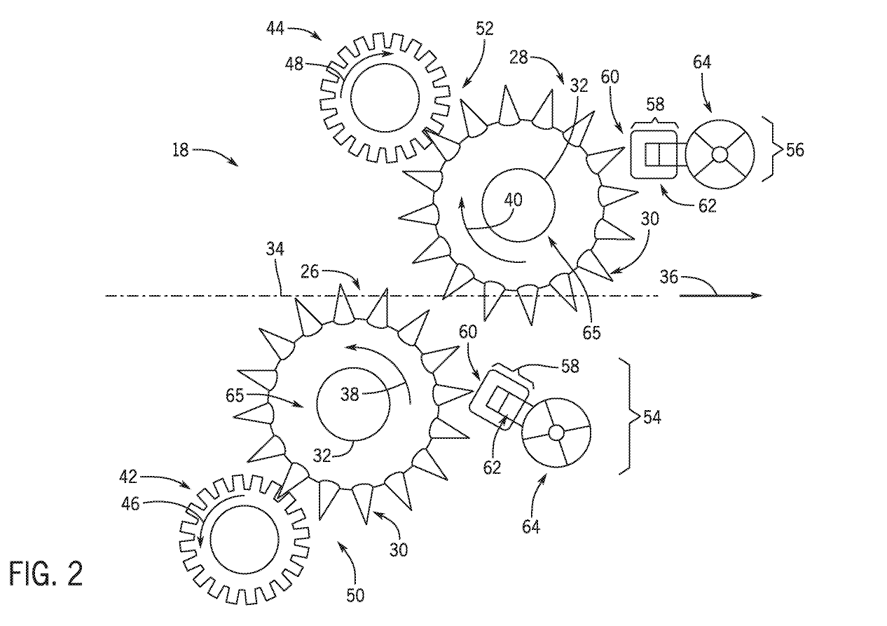

FIG. 2 is a schematic top view of an embodiment of a row unit 18 that may be employed within the agricultural harvester 10 of FIG. 1. In the illustrated embodiment, the row unit 18 includes a first rotor 26 and a second rotor 28. As illustrated, each rotor includes multiple spindles 30 (e.g., barbed spindles) configured to engage a crop (e.g., cotton plant). Each rotor is configured to rotate about a respective central shaft 32 (e.g., rotor shaft). In addition, each rotor includes two end structures rotatably coupled to the central shaft and multiple spindle bars rotatably coupled to the end structures. The spindle bars extend along a vertical axis of the row unit 18, the spindle bars are circumferentially distributed (e.g., evenly circumferentially distributed) about the end structures, and each spindle bar is configured to support multiple spindles. The spindles 30 extend radially outward from each spindle bar, the spindles 30 coupled to each spindle bar are distributed along the vertical axis of the row unit 18, and the spindles 30 coupled to each spindle bar point in the same direction. Because the spindles 30 are distributed along the vertical axis, the spindles 30 engage the crop along a substantial portion of the height of the crop. Furthermore, an orientation control arm is coupled to each spindle bar, a roller is coupled to an end of each orientation control arm, and the rollers engage a cam track. The cam track is configured to control the orientation of each spindle bar relative to the end structures as the rotor rotates, thereby controlling an orientation of the spindles with respect to the crop, with respect to a doffer, and with respect to a moistener column assembly. In addition, each spindle 30 is driven to rotate relative to the respective spindle bar. For example, a spindle drive gear may be coupled to each spindle bar, a spindle gear may be coupled to each spindle, the spindle drive gear may be driven to rotate by rotation of the rotor, and the spindle drive gear may drive the spindle gears to rotate, thereby rotating each spindle. As each spindle engages the agricultural product, rotation of the spindle drives the barbs to capture the agricultural product (e.g., seed cotton), such that the agricultural product wraps around the spindle.

In the illustrated embodiment, the first rotor 26 and the second rotor 28 are positioned on opposite sides of a central path 34 through the row unit 18, and the spindles 30 of each rotor extend into the central path 34. During operation of the agricultural harvester, the central path 34 of the row unit 18 is aligned with a row of crops. Accordingly, as the agricultural harvester traverses the field along a direction of travel 36, the row unit 18 receives each crop of the row, and the spindles 30 of each rotor engage the crop. The first rotor 26 is driven to rotate in a first rotor rotational direction 38, and the second rotor 28 is driven to rotate in a second rotor rotational direction 40, opposite the first rotor rotational direction 38. The rotational speed of each rotor may be selected such that the tangential speed of the spindles 30 due to rotation of the rotor is equal to the ground speed of the row unit 18 along the direction of travel 36, thereby enabling the spindles 30 to engage the crop at a substantially zero relative speed. Engagement of the spindles 30 with the crop separates the agricultural product (e.g., seed cotton) from the plant stalk (e.g., the crop after the agricultural product is removed). While the first and second rotors are positioned on opposite sides of the central path in the illustrated embodiment, in other embodiments, the first and second rotors may be positioned on the same side of the central path.

The agricultural product removed from the crop collects on the spindles 30 of the rotors. In the illustrated embodiment, the row unit 18 includes a first doffer 42 configured to remove the agricultural product from the spindles 30 of the first rotor 26, and the row unit 18 includes a second doffer 44 configured to remove the agricultural product from the spindles 30 of the second rotor 28. Each doffer includes a stack of discs configured to engage the spindles 30 of the respective rotor to remove the agricultural product from the spindles 30. The number of discs of each doffer may be equal to the number of spindles on each spindle bar. As illustrated, the first doffer 42 is configured to rotate in a first doffer rotational direction 46, which is the same as the first rotor rotational direction 38, and the second doffer 44 is configured to rotate in a second doffer rotational direction 48, which is the same as the second rotor rotational direction 40. Each doffer rotates at a rotational speed that establishes a doffer tangential speed greater than a tangential speed of the spindles due to rotation of the spindles relative to the respective spindle bars. Accordingly, the interaction between the discs of the doffer and the spindles 30 of the respective rotor unwinds the agricultural product (e.g., seed cotton) from the spindles 30, thereby removing the agricultural product and directing the agricultural product to a respective conveying chamber. As illustrated, a first conveying chamber 50 is positioned adjacent to the first doffer 42 and the first rotor 26, and a second conveying chamber 52 is positioned adjacent to the second doffer 44 and the second rotor 28. The air-assisted conveying system moves the agricultural product from each conveying chamber to the accumulator.

After the agricultural product is removed from the spindles 30 of the first rotor 26, the spindles 30 pass through a first moistener column assembly 54, and after the agricultural product is removed from the spindles 30 of the second rotor 28, the spindles 30 pass through a second moistener column assembly 56. Each moistener column assembly is configured to remove crop liquids (e.g., sap, etc.) from the spindles 30. In the illustrated embodiment, each moistener column assembly includes multiple moistener pad assemblies 58 distributed along the vertical axis of the row unit. The number of moistener pad assemblies 58 may be equal to the number of spindles 30 on each spindle bar. Each moistener pad assembly 58 includes a moistener pad 60 and a moistener pad holder 62 configured to support the moistener pad 60. Each moistener column assembly also includes a moistener column 64 configured to direct cleaning fluid to each moistener pad assembly 58. The moistener pads 60 are positioned to engage respective spindles 30 as the respective rotor rotates, thereby applying the cleaning fluid to the spindles 30 and wiping the crop liquids off the spindles 30. As the rotors continue to rotate, the spindles 30 engage a subsequent crop at the central path 34.

Furthermore, the row unit 18 also includes a bar lube system configured to lubricate bearings of the row unit 18. In certain embodiments, a bearing 65 may be disposed between each end structure and a respective central shaft 32. Each bearing 65 may be coupled to the respective end structure and to the respective central shaft 32, and each bearing 65 may facilitate rotation of the rotor about the respective central shaft 32. As discussed in detail below, the bar lube system includes an onboard pump assembly configured to supply working fluid (e.g., grease, bar lube, drying agent, anti-spoilage liquid, water, etc.) to an operational output (e.g., including conduit(s)), which extends to the bearings, thereby providing the bearings with the working fluid.

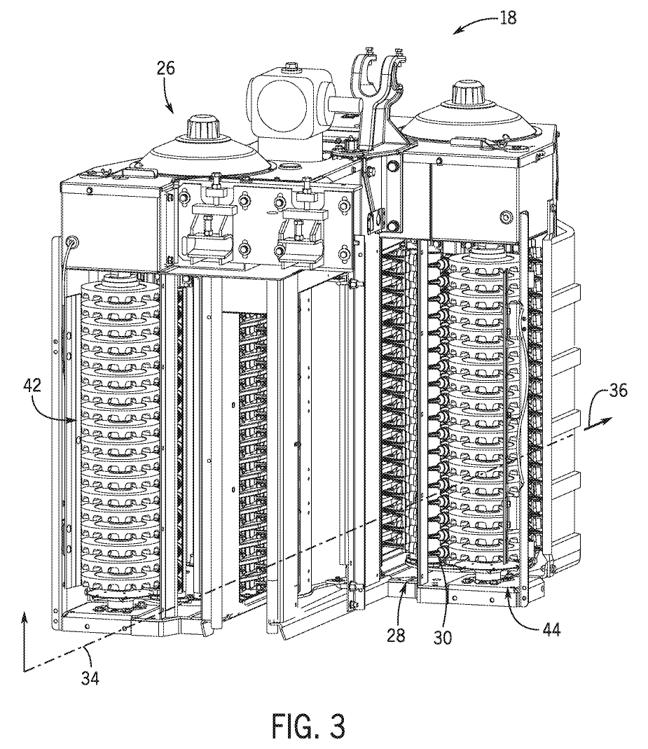

FIG. 3 is a perspective view of the row unit 18 of FIG. 2. In the illustrated embodiment, the row unit 18 includes the first rotor 26 and the second rotor 28. As illustrated, each rotor includes multiple spindles 30. As discussed above, the row unit 18 receives each crop of the row, and the spindles of the rotors engage the crop. The first rotor 26 and the second rotor 28 are positioned on opposite sides of the central path 34 through the row unit 18, and the spindles 30 of each rotor extend into the central path 34. Accordingly, as the agricultural harvester traverses the field along the direction of travel 36, the row unit 18 receives each crop of the row, and the spindles 30 of each rotor engage the crop. The rotors are driven to rotate, such that engagement of the spindles with the crop separates the agricultural product from the plant stalk. In the illustrated embodiment, the row unit 18 includes the first doffer 42 configured to remove the agricultural product from the spindles 30 of the first rotor 26, and the row unit 18 includes the second doffer 44 configured to remove the agricultural product from the spindles 30 of the second rotor 28. The agricultural product removed from the plant stalk collects on the spindles, and the agricultural product is removed from the spindles by the doffers.

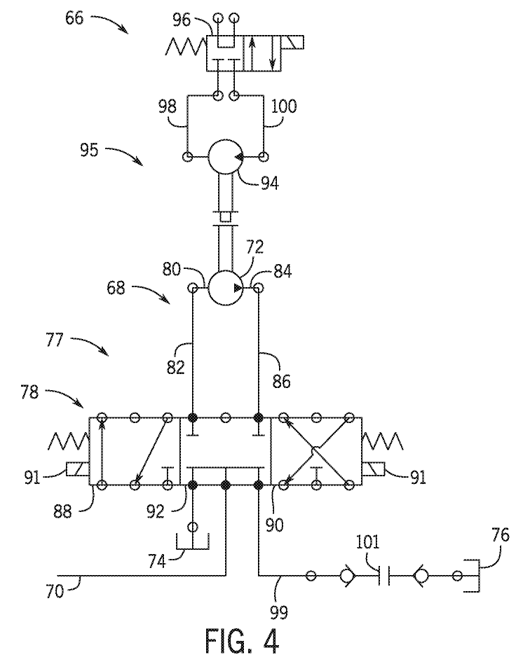

FIG. 4 is a schematic diagram of an embodiment of an onboard pump assembly 66 that may be employed within the agricultural harvester of FIG. 1. In the illustrated embodiment, the onboard pump assembly 66 includes a fluid circuit 68 fluidly coupled to an operational output 70. The onboard pump assembly 66 is positioned onboard the agricultural harvester (e.g., coupled to the chassis of the agricultural harvester). The operational output 70 is configured to provide a working fluid (e.g., grease, bar lube, drying agent, anti-spoilage liquid, water, etc.) to one or more components of the agricultural harvester. For example, the onboard pump assembly 66 may output grease (e.g., bar lube) through the operational output 70 to lubricate bearing(s) coupled to one or more central shafts and respective rotor(s). However, the onboard pump assembly disclosed herein may be used to provide any suitable working fluid (e.g., fuel, oil, water, drying agent, anti-spoilage liquid, etc.) to any suitable component(s) on an agricultural system.

In certain embodiments, the agricultural system may include one onboard pump assembly per row unit. However, in other embodiments, the agricultural harvester may include one onboard pump assembly for all of the row units of the agricultural harvester (e.g., the operational output may extend to all of the bearings of the row units).

In the illustrated embodiment, the onboard pump assembly 66 (e.g., the fluid circuit 68 of the onboard pump assembly 66) includes an onboard pump 72. As illustrated, the onboard pump 72 is a hydraulic pump, however, in other embodiments the onboard pump may be any suitable type of pump. The onboard pump 72 is configured to drive the working fluid from an onboard reservoir 74 to the operational output 70. In addition, the onboard pump 72 is configured to fill the onboard reservoir 74 with the working fluid from a bulk reservoir 76. The onboard reservoir 74 is positioned onboard the agricultural harvester (e.g., coupled to the chassis of the agricultural harvester). In addition, the bulk reservoir 76 is not positioned onboard the agricultural harvester. For example, the bulk reservoir may include a mobile storage tank configured to be positioned adjacent to the agricultural harvester to facilitate transfer of the working fluid from the bulk reservoir 76 to the onboard reservoir 74.

Additionally, the onboard pump assembly 66 includes a valve assembly 77 having one or more valves configured to control the direction of flow of the working fluid output by the pump 72. In the illustrated embodiment, the valve assembly 77 includes a single onboard pump control valve 78. The onboard pump control valve 78 is fluidly coupled to an input end 80 of the onboard pump 72 via a supply line 82, and the onboard pump control valve 78 is fluidly coupled to an output end 84 of the onboard pump 72 via an output line 86. The onboard pump control valve 78 is also fluidly coupled to the operational output 70, to the onboard reservoir 74, and to the bulk reservoir 76.

The onboard pump control valve 78 is configured to transition between an operational position 88 (e.g., operational state) and a filling position 90 (e.g., filling state). In the illustrated embodiment, the valve assembly 77 includes solenoids 91 configured to transition the onboard pump control valve 78 between the operational position 88 and the filling position 90. In the operational position 88, the onboard pump control valve 78 establishes a first connection between the onboard reservoir 74 and the input end 80 of the onboard pump 72 and establishes a second connection between the output end 84 of the onboard pump 72 and the operational output 70. In addition, the onboard pump control valve 78 blocks the bulk reservoir 76 (e.g., blocks flow of the working fluid from the bulk reservoir 76 to the onboard pump 72). Accordingly, while the onboard pump control valve 78 is in the operational position 88, the onboard pump 82 may supply the working fluid to the operational output 70 from the onboard reservoir 74. In the filling position 90, the onboard pump control valve 78 establishes a third connection between the bulk reservoir 76 and the input end 80 of the onboard pump 72 and establishes a fourth connection between the onboard reservoir 74 and the output end 84 of the onboard pump 72. In addition, the onboard pump control valve 78 blocks the operational output 70 (e.g., blocks flow of the working fluid from the onboard pump 72 to the operational output 70). Accordingly, while the onboard pump control valve 78 is in the filling position 90, the onboard pump 82 may fill the onboard reservoir 74 with the working fluid from the bulk reservoir 76. Because the valve assembly enables the onboard pump assembly to both supply working fluid to the operational output and to fill the onboard reservoir, a second pump, which may be used to fill the onboard reservoir in certain working fluid management systems, may be obviated, thereby reducing the cost and complexity associated with managing the working fluid (e.g., as compared to a working fluid management system that includes a second pump for filling the onboard reservoir).

In the illustrated embodiment, the onboard pump control valve 78 is configured to transition to a service position 92. In the service position 92, the onboard pump control valve 78 blocks the input end 80 of the onboard pump 72, blocks the output end 84 of the onboard pump 72, blocks the operational output 70, blocks the onboard reservoir 74, and blocks the bulk reservoir 76. Accordingly, while the onboard pump control valve 78 is in the service position 92, flow of the working fluid to and from the onboard pump 72 is blocked. While the onboard pump control valve includes the service position in the illustrated embodiment, in certain embodiments, the service position may be omitted.

While the valve assembly 77 includes a single onboard pump control valve 78 in the illustrated embodiment, in other embodiments, the valve assembly may include multiple valves. For example, the valve assembly may include a first valve configured to selectively establish a connection between the onboard reservoir 74 and the input end 80 of the onboard pump 72, a second valve configured to selectively establish a connection between the output end 84 of the onboard pump 72 and the operational output 70, a third valve configured to selectively establish a connection between the bulk reservoir 76 and the input end 80 of the onboard pump 72, and a fourth valve configured to selectively establish a connection between the output end 84 of the onboard pump 72 and the onboard reservoir 74. Furthermore, the pump assembly 95 (e.g., the onboard pump control valve 78 of the pump assembly 95) may be manually controlled or automatically controlled (e.g., via solenoids, levers, etc.). For example, in certain embodiments, the onboard pump assembly may include a controller configured to control the valve assembly by actuating multiple solenoids.

The onboard pump 72 is driven by a motor 94. In the illustrated embodiment, the motor 94 is a hydraulic motor, however, in other embodiments the motor may be any suitable type of motor (e.g., electric motor, etc.). The motor 94 may be configured to drive the onboard pump 72 at varying speeds (e.g., faster for filling the onboard reservoir and slower for supplying the working fluid to the operational output). In addition, the onboard pump assembly 66 includes a motor control valve 96 configured to control the flow of hydraulic fluid to the motor 94. For example, in certain embodiments, the motor control valve 96 may be a proportional control valve to control the speed of the motor 94.

In certain embodiments, the motor control valve 96 is positioned on the agricultural harvester (e.g., proximate to the onboard pump 72). The motor control valve 96 is a four-way, two-position directional control valve that is fluidly coupled to a first hydraulic conduit 98 and to a second hydraulic conduit 100. The first and second hydraulic conduits are fluidly coupled to the motor 94. In a first position, as illustrated, the motor control valve 96 is closed, thereby blocking the flow of hydraulic fluid to the motor 94. In a second position, the motor control valve 96 is open, thereby facilitating the flow of hydraulic fluid to the motor 94. In the illustrated embodiment, the position of the motor control valve 96 is controlled by a solenoid, which may be communicatively coupled to a control assembly (e.g., including a controller, a switch, etc.). However, in other embodiments, the motor control valve may be controlled by a hydraulic pilot, a pneumatic pilot, a lever, or another suitable actuator.

As illustrated, a bulk reservoir line 99 extends between the onboard pump control valve 78 of the pump assembly 95 and the bulk reservoir 76. A coupler 101 (e.g., a quick disconnect coupler, etc.) is disposed along the bulk reservoir line 99. The coupler 101 may be any type of suitable connector. For example, in certain embodiments, the coupler 101 is configured to automatically block flow of the working fluid through the bulk reservoir line 99 while the bulk reservoir 76 is disconnected.

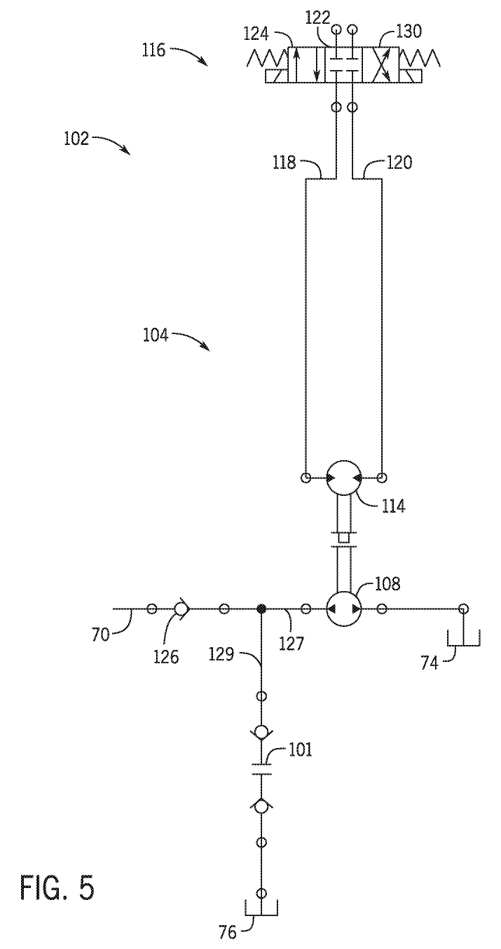

FIG. 5 is a schematic diagram of another embodiment of an onboard pump assembly 102 that may be employed within the agricultural harvester of FIG. 1. The onboard pump assembly 102 is positioned onboard the agricultural harvester (e.g., coupled to the chassis of the agricultural harvester). In the illustrated embodiment, the onboard pump assembly 102 includes a fluid circuit 104 fluidly coupled to the operational output 70. As previously discussed, the operational output 70 is configured to provide the working fluid (e.g., grease, bar lube, drying agent, anti-spoilage liquid, water, etc.) to one or more components of the agricultural harvester. For example, the onboard pump assembly 102 may output grease (e.g., bar lube) through the operational output 70 to lubricate bearing(s) coupled to one or more central shafts of respective rotor(s). However, the onboard pump assembly disclosed herein may be used to provide any suitable working fluid (e.g., fuel, oil, water, drying agent, anti-spoilage liquid, etc.) to any suitable component(s) on an agricultural system.

In the illustrated embodiment, the onboard pump assembly 102 (e.g., the fluid circuit 104 of the onboard pump assembly 102) includes a bi-directional onboard pump 108. As illustrated, the bi-directional onboard pump 108 is a hydraulic pump, however, in other embodiments the bi-directional onboard pump may be any suitable type of bi-directional pump. The bi-directional onboard pump 108 is configured to drive the working fluid from the onboard reservoir 74 to the operational output 70 while operating in a first direction. In addition, the bi-directional onboard pump 108 is configured to fill the onboard reservoir 74 with the working fluid from the bulk reservoir 76 while operating in a second direction, opposite the first direction.

In the illustrated embodiment, the bi-directional onboard pump 108 is coupled to a bi-directional motor 114. As illustrated, the bi-directional motor 114 is a hydraulic motor, however, in other embodiments the bi-directional motor may be any suitable type of bi-directional motor. The bi-directional motor 114 is configured to drive the bi-directional onboard pump 108 to rotate in opposite directions, thereby changing the direction of flow of the working fluid through the bi-directional onboard pump 108. In addition, the onboard pump assembly 102 includes a directional control valve 116 configured to control the flow of hydraulic fluid to the bi-directional motor 114. The directional control valve 116 may be positioned on the agricultural harvester (e.g., proximate to the bi-directional onboard pump 108). In the illustrated embodiment, the directional control valve 116 is a four-way, three-position directional control valve that is fluidly coupled to a first hydraulic conduit 118 and to a second hydraulic conduit 120. The first and second hydraulic conduits are fluidly coupled to the bi-directional motor 114. In a non-operational position 122, as illustrated, the directional control valve 116 is closed, thereby blocking the flow of hydraulic fluid to the bi-directional motor 114. In the illustrated embodiment, the position of the directional control valve 116 is controlled by solenoids, which may be communicatively coupled to a control assembly (e.g., including a controller, one or more switches, etc.). However, in other embodiments, the directional control valve may be controlled by a hydraulic pilot, a pneumatic pilot, a lever, or another suitable actuator.

In an operational position 124, the directional control valve 116 directs pressurized hydraulic fluid to one side of the bi-directional motor 114, thereby causing the bi-directional motor 114 to drive the bi-directional onboard pump 108 to rotate in the first direction. In addition, in a filling position 130, the directional control valve 116 directs pressurized hydraulic fluid to the other side of the bi-directional motor 114, thereby causing the bi-directional motor 114 to drive the bi-directional onboard pump 108 to rotate in the second direction. Rotation of the bi-directional onboard pump 108 in the first direction drives the working fluid to flow from the onboard reservoir 74 to the operational output 70. In addition, rotation of the bi-directional onboard pump 108 in the second direction drives the working fluid to flow from the bulk reservoir 76 to the onboard reservoir 74.

Furthermore, the onboard pump assembly 102 (e.g., the fluid circuit 104 of the onboard pump assembly 102) includes a check valve 126 (e.g., valve) fluidly coupled to the operational output 70. The check valve 126 is configured to facilitate flow of the working fluid from the onboard reservoir 74 to the operational output 70 while the bi-directional onboard pump 108 is operating (e.g., rotating) in the first direction. In addition, the check valve 126 is configured to block flow of the working fluid from the operational output 70 to the onboard reservoir 74 while the bi-directional onboard pump 108 is operating (e.g., rotating) in the second direction. Accordingly, the onboard pump assembly 102 may provide the working fluid to the operational output and to fill the onboard reservoir based on the direction of rotation of the bi-directional onboard pump, which is controlled by the directional control valve 116. While the onboard pump assembly 102 includes a check valve 126 in the illustrated embodiment, in other embodiments, the onboard pump assembly may include another suitable valve configured to open and close to control flow between the operational output and the bi-directional onboard pump (e.g., a solenoid actuated two-position valve). Furthermore, in certain embodiments, another valve (e.g., check valve) may be fluidly coupled to the bulk reservoir and configured to block flow of the working fluid from the onboard reservoir to the bulk reservoir while the bi-directional onboard pump is operating (e.g., rotating) in the first direction and to facilitate flow of the working fluid from the bulk reservoir to the onboard reservoir while the bi-directional onboard pump is operating (e.g., rotating) in the second direction.

As illustrated, a first line 127 extends between the bi-directional onboard pump 108 and the operational output 70, the check valve 126 is positioned on the first line 127, and a second line 129 extends between the bulk reservoir 76 and the first line 127. In the illustrated embodiment, the second line 129 is coupled to the first line 127 between the check valve 126 and the bi-directional onboard pump 108. Furthermore, the coupler 101 (e.g., a quick disconnect coupler, etc.) is disposed along the second line 129. The coupler 101 may be any type of suitable connector. For example, in certain embodiments, the coupler 101 is configured to automatically block flow of the working fluid through the second line 129 while the bulk reservoir 76 is disconnected.

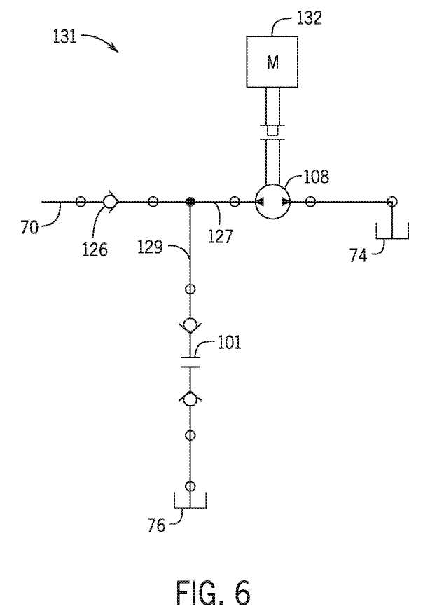

FIG. 6 is a schematic diagram of a further embodiment of an onboard pump assembly that may be employed within the agricultural harvester of FIG. 1. As illustrated, the onboard pump assembly 131 includes an electric motor 132 configured to drive the bi-directional onboard pump to rotate in the first and second directions. The onboard pump assembly 131 is positioned onboard the agricultural harvester (e.g., coupled to the chassis of the agricultural harvester).

As previously discussed, the operational output 70 is configured to provide the working fluid (e.g., grease, bar lube, drying agent, anti-spoilage liquid, water, etc.) to one or more components of the agricultural harvester. For example, the onboard pump assembly 131 may output grease (e.g., bar lube) through the operational output 70 to lubricate bearing(s) coupled to one or more central shafts of respective rotor(s). However, the onboard pump assembly disclosed herein may be used to provide any suitable working fluid (e.g., fuel, oil, water, drying agent, anti-spoilage liquid, etc.) to any suitable component(s) on an agricultural system.

In the illustrated embodiment, the onboard pump assembly 131 includes the bi-directional onboard pump 108. As illustrated, the bi-directional onboard pump 108 is a hydraulic pump, however, in other embodiments the bi-directional onboard pump may be any suitable type of bi-directional pump. The bi-directional onboard pump 108 is configured to drive the working fluid from the onboard reservoir 74 to the operational output 70 while operating in a first direction. In addition, the bi-directional onboard pump 108 is configured to fill the onboard reservoir 74 with the working fluid from the bulk reservoir 76 while operating in a second direction, opposite the first direction.

In the illustrated embodiment, the bi-directional onboard pump 108 is coupled to the electric motor 132. The electric motor 132 is configured to drive the bi-directional onboard pump 108 to rotate in opposite directions, thereby changing the direction of flow of the working fluid through the bi-directional onboard pump 108. Rotation of the bi-directional onboard pump 108 in the first direction drives the working fluid to flow from the onboard reservoir 74 to the operational output 70. In addition, rotation of the bi-directional onboard pump 108 in the second direction drives the working fluid to flow from the bulk reservoir 76 to the onboard reservoir 74.

Furthermore, the onboard pump assembly 131 includes the check valve 126 (e.g., valve) fluidly coupled to the operational output 70. The check valve 126 is configured to facilitate flow of the working fluid from the onboard reservoir 74 to the operational output 70 while the bi-directional onboard pump 108 is operating (e.g., rotating) in the first direction. In addition, the check valve 126 is configured to block flow of the working fluid from the operational output 70 to the onboard reservoir 74 while the bi-directional onboard pump 108 is operating (e.g., rotating) in the second direction. Accordingly, the onboard pump assembly 131 may provide the working fluid to the operational output and to fill the onboard reservoir based on the direction of rotation of the bi-directional onboard pump, which is controlled by controlling the direction of rotation of the electric motor 132. While the onboard pump assembly 131 includes the check valve 126 in the illustrated embodiment, in other embodiments, the onboard pump assembly may include another suitable valve configured to open and close to control flow between the operational output and the bi-directional onboard pump (e.g., a solenoid actuated two-position valve). Furthermore, in certain embodiments, another valve (e.g., check valve) may be fluidly coupled to the bulk reservoir and configured to block flow of the working fluid from the onboard reservoir to the bulk reservoir while the bi-directional onboard pump is operating (e.g., rotating) in the first direction and to facilitate flow of the working fluid from the bulk reservoir to the onboard reservoir while the bi-directional onboard pump is operating (e.g., rotating) in the second direction.

As illustrated, the first line 127 extends between the bi-directional onboard pump 108 and the operational output 70, the check valve 126 is positioned on the first line 127, and the second line 129 extends between the bulk reservoir 76 and the first line 127. In the illustrated embodiment, the second line 129 is coupled to the first line 127 between the check valve 126 and the bi-directional onboard pump 108. Furthermore, the coupler 101 (e.g., a quick disconnect coupler, etc.) is disposed along the second line 129. The coupler 101 may be any type of suitable connector. For example, in certain embodiments, the coupler 101 is configured to automatically block flow of the working fluid through the second line 129 while the bulk reservoir 76 is disconnected.

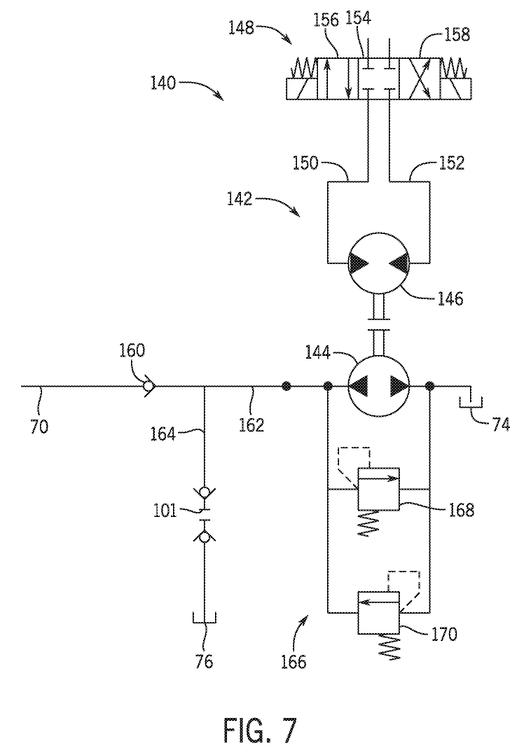

FIG. 7 is a schematic diagram of an additional embodiment of an onboard pump assembly 140 that may be employed within the agricultural harvester of FIG. 1. The onboard pump assembly 140 is positioned onboard the agricultural harvester (e.g., coupled to the chassis of the agricultural harvester). In the illustrated embodiment, the onboard pump assembly 140 includes a fluid circuit 142 fluidly coupled to the operational output 70. As previously discussed, the operational output 70 is configured to provide the working fluid (e.g., grease, bar lube, drying agent, anti-spoilage liquid, water, etc.) to one or more components of the agricultural harvester. For example, the onboard pump assembly 140 may output grease (e.g., bar lube) through the operational output 70 to lubricate bearing(s) coupled to one or more central shafts of respective rotor(s). However, the onboard pump assembly disclosed herein may be used to provide any suitable working fluid (e.g., fuel, oil, water, drying agent, anti-spoilage liquid, etc.) to any suitable component(s) on an agricultural system.

In the illustrated embodiment, the onboard pump assembly 140 (e.g., the fluid circuit 142 of the onboard pump assembly 140) includes a bi-directional onboard pump 144. As illustrated, the bi-directional onboard pump 144 is a hydraulic pump, however, in other embodiments the bi-directional onboard pump may be any suitable type of bi-directional pump. The bi-directional onboard pump 144 is configured to drive the working fluid from the onboard reservoir 74 to the operational output 70 while operating in a first direction. In addition, the bi-directional onboard pump 144 is configured to fill the onboard reservoir 74 with the working fluid from the bulk reservoir 76 while operating in a second direction, opposite the first direction.

In the illustrated embodiment, the bi-directional onboard pump 144 is coupled to a bi-directional motor 146. As illustrated, the bi-directional motor 146 is a hydraulic motor, however, in other embodiments the bi-directional motor may be any suitable type of bi-directional motor (e.g., electric motor). The bi-directional motor 146 is configured to drive the bi-directional onboard pump 144 to rotate in opposite directions, thereby changing the direction of flow of the working fluid through the bi-directional onboard pump 144. In addition, the onboard pump assembly 140 includes a directional control valve 148 configured to control the flow of hydraulic fluid to the bi-directional motor 146. The directional control valve 148 may be positioned on the agricultural harvester (e.g., proximate to the bi-directional onboard pump 144). In the illustrated embodiment, the directional control valve 148 is a four-way, three-position directional control valve that is fluidly coupled to a first hydraulic conduit 150 and to a second hydraulic conduit 152. The first and second hydraulic conduits are fluidly coupled to the bi-directional motor 146. In a non-operational position 154, as illustrated, the directional control valve 148 is closed, thereby blocking the flow of hydraulic fluid to the bi-directional motor 146. In the illustrated embodiment, the position of the directional control valve 148 is controlled by solenoids, which may be communicatively coupled to a control assembly (e.g., including a controller, one or more switches, etc.). However, in other embodiments, the directional control valve may be controlled by a hydraulic pilot, a pneumatic pilot, a lever, or another suitable actuator.

In an operational position 156, the directional control valve 148 directs pressurized hydraulic fluid to one side of the bi-directional motor 146, thereby causing the bi-directional motor 146 to drive the bi-directional onboard pump 144 to rotate in the first direction. In addition, in a filling position 158, the directional control valve 148 directs pressurized hydraulic fluid to the other side of the bi-directional motor 146, thereby causing the bi-directional motor 146 to drive the bi-directional onboard pump 144 to rotate in the second direction. Rotation of the bi-directional onboard pump 144 in the first direction drives the working fluid to flow from the onboard reservoir 74 to the operational output 70. In addition, rotation of the bi-directional onboard pump 144 in the second direction drives the working fluid to flow from the bulk reservoir 76 to the onboard reservoir 74.

Furthermore, the onboard pump assembly 140 (e.g., the fluid circuit 142 of the onboard pump assembly 140) includes a check valve 160 (e.g., valve) fluidly coupled to the operational output 70. The check valve 160 is configured to facilitate flow of the working fluid from the onboard reservoir 74 to the operational output 70 while the bi-directional onboard pump 144 is operating (e.g., rotating) in the first direction. In addition, the check valve 160 is configured to block flow of the working fluid from the operational output 70 to the onboard reservoir 74 while the bi-directional onboard pump 144 is operating (e.g., rotating) in the second direction. Accordingly, the onboard pump assembly 140 may provide the working fluid to the operational output and to fill the onboard reservoir based on the direction of rotation of the bi-directional onboard pump, which is controlled by the directional control valve 148. While the onboard pump assembly 140 includes a check valve 160 in the illustrated embodiment, in other embodiments, the onboard pump assembly may include another suitable valve configured to open and close to control flow between the operational output and the bi-directional onboard pump (e.g., a solenoid actuated two-position valve). Furthermore, in certain embodiments, another valve (e.g., check valve) may be fluidly coupled to the bulk reservoir and configured to block flow of the working fluid from the onboard reservoir to the bulk reservoir while the bi-directional onboard pump is operating (e.g., rotating) in the first direction and to facilitate flow of the working fluid from the bulk reservoir to the onboard reservoir while the bi-directional onboard pump is operating (e.g., rotating) in the second direction.

As illustrated, a first line 162 extends between the bi-directional onboard pump 144 and the operational output 70, the check valve 160 is positioned on the first line 162, and a second line 164 extends between the bulk reservoir 76 and the first line 162. In the illustrated embodiment, the second line 164 is coupled to the first line 162 between the check valve 160 and the bi-directional onboard pump 144. Furthermore, the coupler 101 (e.g., a quick disconnect coupler, etc.) is disposed along the second line 164. The coupler 101 may be any type of suitable connector. For example, in certain embodiments, the coupler 101 is configured to automatically block flow of the working fluid through the second line 164 while the bulk reservoir 76 is disconnected.

In the illustrated embodiment, a relief valve assembly 166 is coupled to the bi-directional onboard pump 144 or integrated within the bi-directional onboard pump 144. The relief valve assembly 166 may be asymmetrical to establish different fluid pressures based on the direction of operation (e.g., rotation) of the bi-directional onboard pump 144. For example, the relief valve system 166 may include a first relief valve 168 configured to establish a first pressure of the working fluid to the operational output 70 while the bi-directional onboard pump 144 is operating (e.g., rotating) in the first direction, and the relief valve system 166 may include a second relief valve 170 configured to establish a second pressure of the working fluid to the onboard reservoir 74 while the bi-directional onboard pump 144 is operating (e.g., rotating) in the second direction. In certain embodiments, the first pressure of the working fluid to the operational output 70 may be lower than the second pressure of the working fluid to the onboard reservoir 74. For example, the first pressure may be 150 psi (e.g., 10.3 bar), and the second pressure may be 260 psi (e.g., 17.9 bar). The onboard pump assembly 140 may provide the working fluid to the operational output 70 at a lower pressure while the bi-directional onboard pump 144 is operating (e.g., rotating) in the first direction (e.g., to facilitate operation of the component(s) of the agricultural harvester), and the onboard pump assembly 140 may provide the working fluid to the onboard reservoir 74 at a higher pressure while the bi-directional onboard pump 144 is operating (e.g., rotating) in the second direction (e.g., to overcome head pressure between the bi-directional onboard pump 144 and the onboard reservoir 74 and/or to fill the onboard reservoir 74 quickly).

While an asymmetrical relief valve assembly 166 is disclosed above, in certain embodiments, the relief valve assembly may be symmetrical, thereby providing the working fluid to the operational output and to the onboard reservoir at equal pressures. In addition, while the relief valve assembly 166 includes two relief valves in the illustrated embodiment, in certain embodiments, the relief valve assembly may include a single relief valve. For example, the second relief valve may be omitted, such that the second pressure of the working fluid to the onboard reservoir is equal to the full output pressure of the bi-directional onboard pump. Furthermore, while the bi-directional onboard pump 144 is driven to rotate by the hydraulic bi-directional motor 146 in the illustrated embodiment, in other embodiments, the bi-directional onboard pump may be driven to rotate by an electric motor, such as the electric motor disclosed above with reference to FIG. 6. The electric motor may drive the bi-directional onboard pump to rotate in opposite directions, thereby changing the direction of flow of the working fluid through the bi-directional onboard pump.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] …” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

1. An agricultural harvester comprising an onboard pump assembly, comprising:
an onboard pump configured to:
supply a working fluid to an operational output from an onboard reservoir; and
fill the onboard reservoir with the working fluid from a bulk reservoir; and
a valve assembly configured to transition between an operational state and a filling state;
wherein the valve assembly, while in the operational state:
establishes a first connection between the onboard reservoir and an input end of the onboard pump;
establishes a second connection between the operational output and an output end of the onboard pump; and
blocks the bulk reservoir; and
wherein the valve assembly, while in the filling state:
establishes a third connection between the bulk reservoir and the input end of the onboard pump;
establishes a fourth connection between the onboard reservoir and the output end of the onboard pump; and
blocks the operational output.

2. The agricultural harvester of claim 1, wherein the valve assembly is configured to transition to a service position, and the valve assembly, while in the service position, blocks the input end of the onboard pump, blocks the output end of the onboard pump, blocks the operational output, blocks the onboard reservoir, and blocks the bulk reservoir.

3. The agricultural harvester of claim 1, wherein the valve assembly comprises at least one solenoid configured to transition the valve assembly between the operational state and the filling state.

4. The agricultural harvester of claim 1, wherein the onboard pump assembly comprises a hydraulic motor configured to drive the onboard pump to rotate.

5. The agricultural harvester of claim 4, wherein the onboard pump assembly comprises a motor control valve configured to control flow of hydraulic fluid to the hydraulic motor.

6. An agricultural harvester comprising an onboard pump assembly, comprising:
a bi-directional onboard pump configured to:
supply a working fluid to an operational output from an onboard reservoir while operating in a first direction; and
fill the onboard reservoir with the working fluid from a bulk reservoir while operating in a second direction, opposite the first direction; and
a valve configured to:
facilitate flow of the working fluid from the onboard reservoir to the operational output while the bi-directional onboard pump is operating in the first direction; and
block flow of the working fluid from the operational output to the onboard reservoir while the bi-directional onboard pump is operating in the second direction.

7. The agricultural harvester of claim 6, a relief valve assembly coupled to the bi-directional onboard pump or integrated within the bi-directional onboard pump, wherein the relief valve assembly is configured to establish a first pressure of the working fluid to the operational output while the bi-directional onboard pump is operating in the first direction and to establish a second pressure of the working fluid to the onboard reservoir while the bi-directional onboard pump is operating in the second direction.

8. The agricultural harvester of claim 7, wherein the first pressure is lower than the second pressure.

9. The agricultural harvester of claim 6, wherein the valve comprises a check valve.

10. The agricultural harvester of claim 6, wherein the onboard pump assembly comprises a coupler configured to connect the bulk reservoir to the bi-directional onboard pump.

11. The agricultural harvester of claim 6, wherein the onboard pump assembly comprises a hydraulic motor configured to drive the bi-directional onboard pump to rotate.

12. The agricultural harvester of claim 11, wherein the onboard pump assembly comprises a directional control valve configured to control flow of hydraulic fluid to the hydraulic motor.

13. The agricultural harvester of claim 6, comprising an electric motor configured to drive the bi-directional onboard pump to rotate.

14. An agricultural harvester, comprising:
a row unit comprising:
a rotor having a plurality of spindles;
a central shaft, wherein the rotor is configured to rotate about the central shaft; and
a bearing disposed between the rotor and the central shaft; and
an onboard pump assembly comprising:
an onboard pump configured to:
supply a working fluid to an operational output from an onboard reservoir, wherein the operational output is fluidly coupled to the bearing; and
fill the onboard reservoir with the working fluid from a bulk reservoir; and
a valve assembly configured to transition between an operational state and a filling state;
wherein the valve assembly, while in the operational state:
establishes a first connection between the onboard reservoir and an input end of the onboard pump;
establishes a second connection between the operational output and an output end of the onboard pump; and
blocks the bulk reservoir; and
wherein the valve assembly, while in the filling state:
establishes a third connection between the bulk reservoir and the input end of the onboard pump;
establishes a fourth connection between the onboard reservoir and the output end of the onboard pump; and
blocks the operational output.

15. The agricultural harvester of claim 14, wherein the valve assembly is configured to transition to a service position, and the valve assembly, while in the service position, blocks the input end of the onboard pump, blocks the output end of the onboard pump, blocks the operational output, blocks the onboard reservoir, and blocks the bulk reservoir.

16. The agricultural harvester of claim 14, wherein the valve assembly comprises at least one solenoid configured to transition the valve assembly between the operational state and the filling state.

17. The agricultural harvester of claim 14, wherein the onboard pump assembly comprises a hydraulic motor configured to drive the onboard pump to rotate.

18. The agricultural harvester of claim 17, wherein the onboard pump assembly comprises a motor control valve configured to control flow of hydraulic fluid to the hydraulic motor.

19. The agricultural harvester of claim 14, wherein the onboard pump assembly comprises a quick disconnect coupler configured to connect the valve assembly to the bulk reservoir.

20. The agricultural harvester of claim 14, wherein the working fluid comprises grease.
